(19) United States
(12) Patent Application Publication
(10) Pub. No.: US 2018/0333996 A1
(43) Pub. Date: Nov. 22, 2018

(54) TUBELESS TIRE SEATING TOOL

(71) Applicant: Christopher Canfield, Bellingham, WA (US)

(72) Inventor: Christopher Canfield, Bellingham, WA (US)

(21) Appl. No.: 15/984,248

(22) Filed: May 18, 2018

Related U.S. Application Data
(60) Provisional application No. 62/508,169, filed on May 18, 2017.

(51) Int. Cl. B60C 25/14

(52) U.S. Cl. CPC B60C 25/145

(57) ABSTRACT

A tubeless tire seating tool is disclosed. The tubeless tire seating tool includes a tube and a sealing stem. The tube is inflatable to apply pressure to a tubeless tire on a tire side of a wheel to seat the tubeless tire on the wheel. The sealing stem is coupled to the tube to facilitate delivery of a fluid into the tube to apply the pressure to the tubeless tire. The sealing stem includes a sealing element external to the sealing stem and forming a seal on the wheel to prevent the fluid from escaping around the sealing stem from within the tubeless tire in response to a failure of the tube.

### CROSS-REFERENCES TO RELATED APPLICATIONS

This application claims the benefit of U.S. Provisional Patent Application No. 62/508,169 entitled “Tubeless tire seating tool” and filed on 18 May 2017 for Chris Canfield, the entire contents of which are incorporated herein by reference for all purposes.

### FIELD

This invention relates to seating tires and more specifically to a tool for seating tubeless tires.

### BACKGROUND

Tubeless tires have many benefits over pneumatic or tube-lined tires. Generally, tubeless tires are lighter, have lower rolling resistance, have a slower decompression rate upon puncture (making them safer in some applications), have more even tire pressure, and can run lower pressures without the risk of a pinch flat. Due to these and other advantages, the use of tubeless tires is popular on many different types of vehicles.

### SUMMARY

A tubeless tire seating tool is disclosed. The tubeless tire seating tool includes a tube and a sealing stem. The tube is inflatable to apply pressure to a tubeless tire on a tire side of a wheel to seat the tubeless tire on the wheel. The sealing stem is coupled to the tube to facilitate delivery of a fluid into the tube to apply the pressure to the tubeless tire. The sealing stem includes a sealing element external to the sealing stem and forming a seal on the wheel to prevent the fluid from escaping around the sealing stem from within the tubeless tire in response to a failure of the tube.

A tubeless tire system is also disclosed. The tubeless tire system includes a tubeless wheel, a tubeless tire, and a tubeless tire seating tool. The tubeless tire is disposed on the tubeless wheel. The tubeless tire seating tool is configured to seat and at least partially inflate the tubeless tire on the tubeless wheel. The tubeless tire seating tool includes a tube and a sealing stem. The tube is inflatable to apply pressure to the tubeless tire on a tire side of the tubeless wheel to seat the tubeless tire on the tubeless wheel. The sealing stem is coupled to the tube to facilitate delivery of a fluid into the tube to apply the pressure to the tubeless tire. The sealing stem includes a sealing element external to the sealing stem and forming a seal on the tubeless wheel to prevent the fluid from escaping around the sealing stem from within the tubeless tire in response to a failure of the tube.

A method is also disclosed. The method includes inserting a seating tool between a tire and a wheel. The method also includes securing a sealing stem of the seating tool in a wheel stem port of the wheel. The method also includes inflating the seating tool to a tire seating pressure to seat the tire on the wheel. The method also includes inflating the tire to an operating pressure to burst the seating tool.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic view of one embodiment of a tire seating tool;

FIG. 2 is a schematic view of another embodiment of a tire seating tool;

FIG. 3 is a schematic view of one embodiment of a sealing stem for a tire seating tool;

FIG. 4 is a schematic view of another embodiment of a sealing stem for a tire seating tool;

FIG. 5 is a schematic view of another embodiment of a sealing stem for a tire seating tool;

FIG. 6 is a schematic view of another embodiment of a sealing stem for a tire seating tool;

FIG. 7 is a schematic view of another embodiment of a sealing stem for a tire seating tool;

FIG. 8 is a schematic view of another embodiment of a sealing stem for a tire seating tool;

FIG. 9 is a schematic view of another embodiment of a sealing stem for a tire seating tool;

FIG. 10 is a schematic view of another embodiment of a sealing stem for a tire seating tool;

FIG. 11 is a schematic cross-sectional view of one embodiment of a seating tool installed in a tubeless tire system; and

FIG. 12 is a flowchart of one embodiment of a method for using the seating tool.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

In the above description, certain terms may be used such as “up,” “down,” “upper,” “lower,” “upward,” “downward,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of” or “one or more”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Furthermore, the described features, structures, or characteristics of the invention may be combined in any suitable manner in one or more embodiments. In the following description, numerous specific details are provided to facilitate a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The flowcharts included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, any format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding blocks shown.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations of apparatuses, systems, and methods according to various embodiments of the present invention. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment

Embodiments described pertain to a tire seating tool for seating tubeless tires. In the embodiments described below, the tire seating tool provides a system for seating a tubeless tire using a relatively thin tube with a sealing stem attached. In some example, the tire seating tool is inserted into a tubeless tire on a wheel. The sealing stem is secured in the wheel stem port. The tubeless tire is situated in position relative to the wheel for seating the tire on the wheel. The seating tool is inflated to a seating pressure sufficient to seat the tubeless tire on the wheel. Additional inflation is applied to bring the tubeless tire to an operating pressure of the tubeless tire. In some examples, the seating tool may burst or fail at pressures above the seating pressure. However, after the tire is seating, the bursting or failing of the seating tool does not affect the pressurization of the tire because the tubeless tire in combination with the sealing stem of the seating tool maintains the pressure of the tubeless system. In this manner, the difficulty of seating a new or previously used tubeless tire is reduced. Additional details are included below with respect to the various corresponding figures.

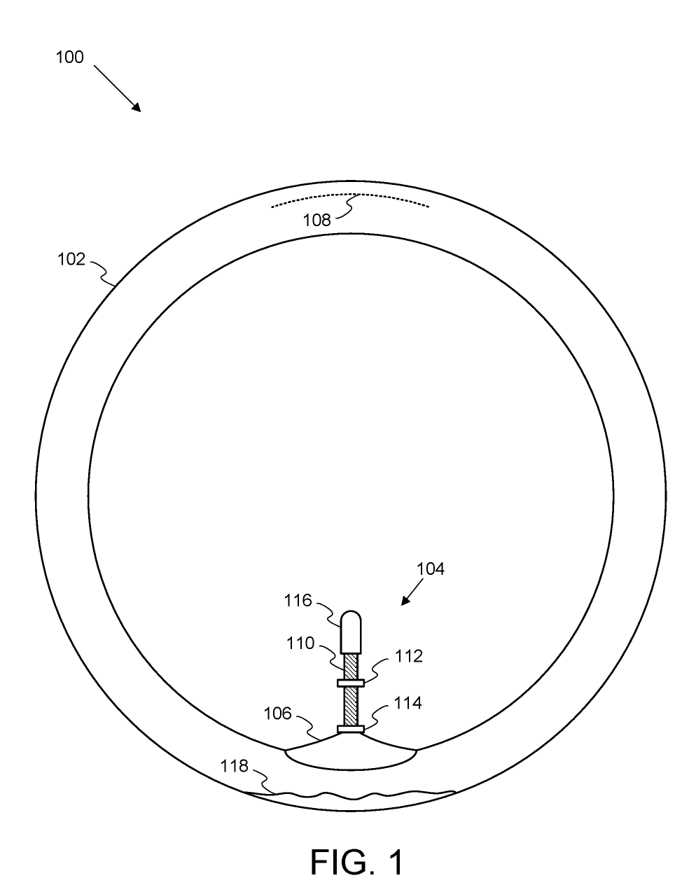

FIG. 1 is a schematic view of one embodiment of a tire seating tool 100. The illustrated embodiment of the seating tool 100 includes a tube 102 and a sealing stem 104. In the illustrated embodiment, the sealing stem 104 is attached to the tube 102 via a skirt 106. In other embodiments, the skirt 106 is omitted.

In some embodiments, the tube 102 has relatively thin walls. In some embodiments, the tube 102 has a wall thickness of approximately 0.45 millimeters. In other embodiments, the tube 102 has a wall thickness of less than approximately 0.45 millimeters. Other embodiments, may include other thicknesses.

In some embodiments, the tube 102 has a uniform wall thickness. In other embodiments, the tube 102 has a non-uniform wall thickness. In other words, in some embodiments, the tube 102 has two or more regions having different wall thicknesses. In some embodiments, the different regions of wall thicknesses are joined at a transition region in which the wall thickness gradually or abruptly changes from one thickness to the other.

In some embodiments, the tube 102 is configured to contain sufficient pressure to seat a bead of a tubeless tire onto corresponding region of a wheel. In some embodiments, the tube 102 is a sacrificial tube in that the tube 102 may burst or otherwise fail after seating the tubeless tire on the wheel and potentially before or after reaching an operating pressure.

In the illustrated embodiment, the tube 102 is sacrificial because the tube 102 includes a weakness 108. In some embodiments, the weakness 108 is a location on the tube 102 at which the tube wall is thinner or otherwise prone to failure. For example, the weakness may be a thinned area, a separation, a perforation, or other structural variation in the wall of the tube 102. In some embodiments, the weakness 108 is intentionally formed in the tube 102. In other embodiments, the weakness 108 is a consequence of a manufacturing process for forming the tube 102. In other embodiments, no weakness is created in the tube 102.

In some embodiments, the weakness 108 forms a location in the tube 102 at which the tube 102 will burst if the maximum pressure of the tube 102 is exceeded. In some embodiments, the maximum pressure of the tube 102 is between the seating pressure to seat the tubeless tire on the wheel and the operating pressure of the tubeless tire.

In the illustrated embodiment, the skirt 106 is a flexible or rigid structure connecting the sealing stem 104 to the tube 102 of the seating tool 100. In some embodiments, the skirt 106 includes the same or similar material to that of the tube 102. In other embodiments, at least a portion of the material of the skirt 106 is different from the material of the tube 102.

In the illustrated embodiment, the sealing stem 104 includes a shaft 110. In some embodiments, the shaft 110 includes a threaded portion. In other embodiments, the shaft 110 is a smoothed, notched, ridged, dimpled, or otherwise surfaced structure.

The illustrated embodiment of the sealing stem 104 also includes a securing nut 112, a sealing element 114, and a cap 116. In some embodiments, the shaft 110 is a metal. In other embodiments, the shaft 110 is plastic.

In some embodiments, the shaft 110 of the sealing stem 104 is coated with a functional material. For example, the shaft 110 may be treated with a thread locker to reduce the chance that the securing nut 112 may become unintentionally loosened on the shaft 110. In another example, the shaft 110 is coated with a lubricant to facilitate movement of the securing nut 112 relative to the shaft 110. In another example, the shaft 110 includes a protective coating to reduce damage, oxidation, or other degradation that may occur on the shaft 110.

In some embodiments, the securing nut 112 can be spun relative to the shaft 110 to move the securing nut 112 nearer to or further from the sealing element 114. In other embodiments, the securing nut 112 is moved down the shaft 110 in other manners. For example, the securing nut 112 may include a friction lock, spring pin, or other mechanism to secure the securing nut 112 relative to the shaft 110.

In some embodiments, the securing nut 112 is configured to be placed on the shaft 110 after the shaft 110 is inserted into a stem port of a wheel. In some embodiments, a major diameter of the securing nut 112 is greater than a diameter of the stem port of the wheel such that the securing nut 112 will not pass through the stem port.

In some embodiments, the securing nut 112 is tightened towards the sealing element 114 to secure the sealing element 114 against a tire side of the wheel with the securing nut 112 on an opposite side (or axle side) of the wheel. In other embodiments described below, the securing nut 112 and the sealing element 114 may be arranged in other manners.

In some embodiments, the sealing element 114 is a separate structure. In other embodiments, the sealing element 114 is a unified portion of the shaft 110. In some embodiments, the sealing element 114 is unified with the skirt 106. Other arrangements are also contemplated. Further examples are described below.

In the illustrated embodiment, the cap 116 is secured on an end of the sealing stem 104. In some embodiments, the cap 116 prevents dust and debris from entering the sealing stem 104. In some embodiments, the cap 116 protects components which form a valve core within the sealing stem 104. In some embodiments, the cap 116 may be unified with the securing nut 112. In other embodiments, the cap 116 and the securing nut 112 are separate.

In the illustrated embodiment, the tube 102 is charged with sealant 118. In some embodiments, the tube 102 does not include sealant. In some embodiments, in response to failure of the tube 102, the seating tool 100 releases the sealant 118 to an interior of the tubeless tire to prevent leaks and pressure loss due to puncture or other compromises in the tire.

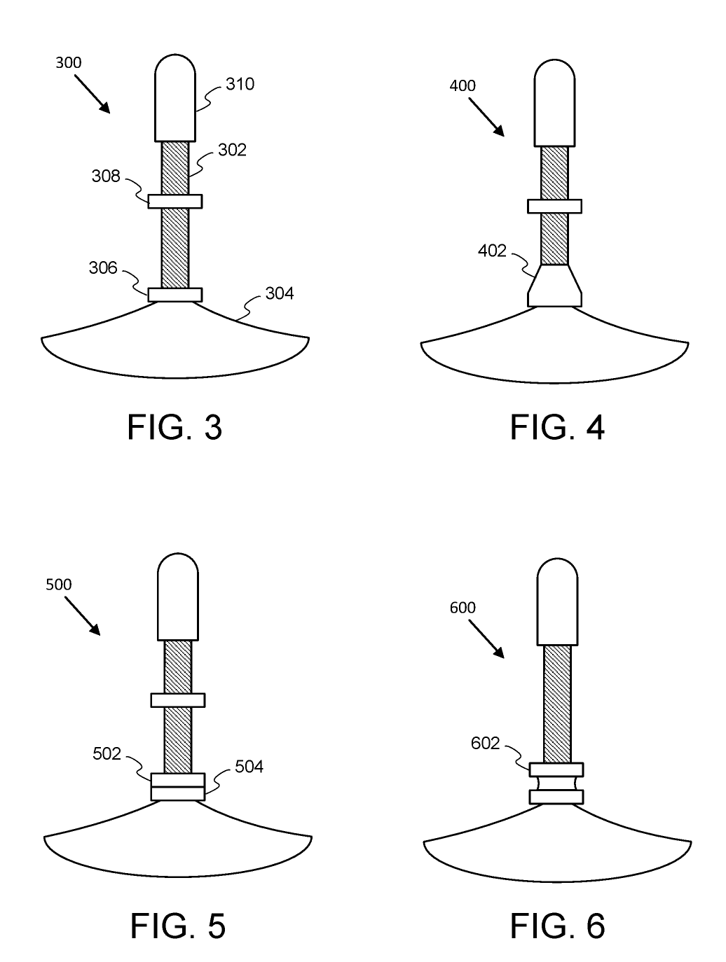

In some embodiments, the weakness 108 helps to distribute the sealant 118 in a corresponding pattern or rate in response to the tube 102 bursting at the weakness 108. In other embodiments, the tube 102 does not include a weakness 108 and the sealant 118 escapes the tube 102 at whatever burst point(s) occurs in the tube 102. Additional information and examples for the sealing stem 104 are described below with reference to FIGS. 3-10.

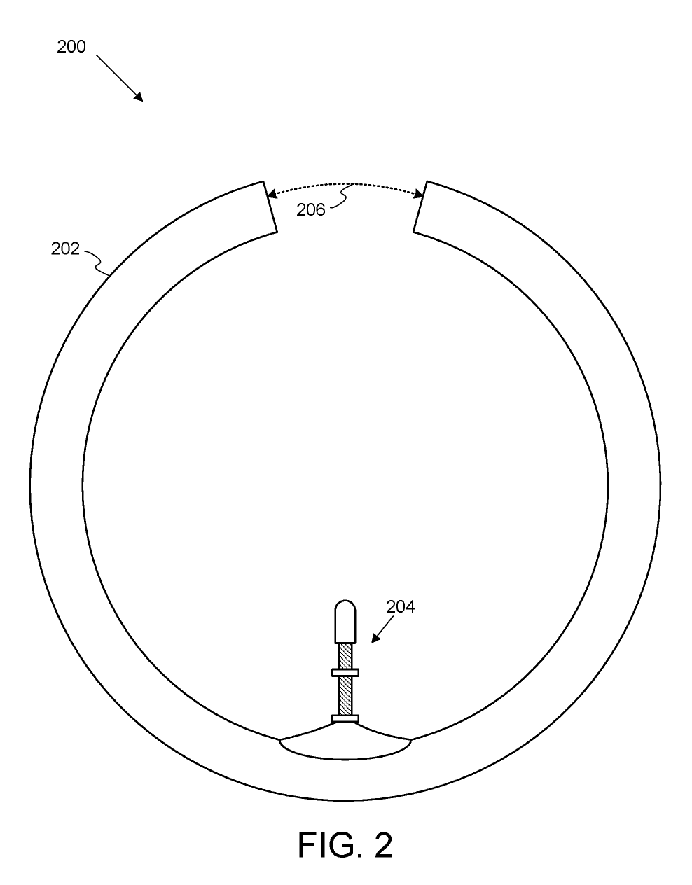

FIG. 2 is a schematic view of another embodiment of a tire seating tool 200. In many ways, the tire seating tool 200 of FIG. 2 is similar to the tire seating tool 100 of FIG. 1. However, in the illustrated embodiment, the tube 202 of FIG. 2 is a “c-shaped” tube with free ends. In other words, in the illustrated embodiment, the tube 202 does not form a full circle. In some embodiments, the c-shape of the tube 202 facilitates feeding of the seating tool 200 into the tire without having to fully separate the tubeless tire from the wheel. In other words, the c-shape of the tube 202 may allow the seating tool 200 to be slid into a relatively small area at which the tubeless tire is separated from the wheel.

In the illustrated embodiment, the tube 202 includes the sealing stem 204 approximately midway between the ends of the tube 202. In other embodiments, the sealing stem 204 is located on the tube 202 at a location nearer to one end of the tube 202 than the other. In some embodiments, the stem 204 may be located at one end of the tube 202 to provide a single end of the tube 202 to be fed into the tubeless tire. For example, with the sealing stem 204 located at or near one end of the c-shaped tube 202, the other end may be fed into the tire near the stem port to install the seating tool 200 without having to feed the second end into the tire in the other direction. In some embodiments, this may help to prevent twisting of the tube 202 during installation.

In the illustrated embodiment, the tube 202 includes a gap between the two ends. In some embodiments, the gap 206 is sufficient to allow expansion of the tube 202 during pressurization to close or nearly close the gap 206. In some embodiments, the gap 206 is a separation in the ends without introducing any significant gap. In other words, in some embodiments, the gap 206 between the two ends of the tube 202 is approximately zero.

In the illustrated embodiments, the ends of the tube 202 at the gap 206 are flat. In other embodiments, the ends of the tube 202 at the gap 206 are rounded, partially rounded, pointed, conical, pinched, or have another geometry. In some embodiments, the ends of the tube 202 have the same geometry or different geometries. For example, the ends of the tube 202 may have a complimentary geometry to facilitate an aligning or joining of the ends together inside the tire during filling. For example, one end of the tube 202 may be convex while the other is concave to receive the convex end during pressurization of the tube 202.

In some embodiments, the ends of the tube 202 include a harder or thicker material to facilitate insertion of the tube 202 into the tire to be inflated. In other embodiments, a string or other structure may be applied to one or both ends of the tube 202 to pull the corresponding end through the interior path of the tubeless tire.

FIG. 3 is a schematic view of one embodiment of a sealing stem 300 for a tire seating tool. The illustrated embodiment is substantially similar to the sealing stem 104 of FIG. 1 as described above.

In the illustrated embodiment, the sealing stem 300 includes a shaft 302. In some embodiments, the shaft 302 includes a threaded portion. In other embodiments, the shaft 302 is a smoothed, notched, ridged, dimpled, or otherwise surfaced structure.

The illustrated embodiment of the sealing stem 300 also includes a securing nut 308, a sealing element 306, and a cap 310. In some embodiments, the shaft 302 is a metal. In other embodiments, the shaft 302 is plastic or another non-metal.

In some embodiments, the shaft 302 of the sealing stem 300 is coated with a functional material. For example, the shaft 302 may be coated with a thread locker to reduce the chance that the securing nut 308 may become unintentionally loosened on the shaft 302. In another example, the shaft 302 is coated with a lubricant to facilitate movement of the securing nut 308 relative to the shaft 302. In another example, the shaft 302 includes a protective coating to reduce damage, oxidation, or other degradation that may occur on the shaft 302.

In some embodiments, the securing nut 308 can be spun relative to the shaft 302 to move the securing nut 308 nearer to or further from the sealing element 306. In other embodiments, the securing nut 308 is moved down the shaft 302 in other manners. For example, the securing nut 308 may include a friction lock, spring pin, or other mechanism to secure the securing nut 308 relative to the shaft 302.

In some embodiments, the securing nut 308 is configured to be placed on the shaft 302 after the shaft 302 is inserted into a stem port of a wheel. In some embodiments, a major diameter of the securing nut 308 is greater than a diameter of the stem port of the wheel such that the securing nut 308 will not pass through the stem port.

In some embodiments, the securing nut 308 is tightened towards the sealing element 306 to secure the sealing element against a tire side of the wheel with the securing nut 308 on an opposite side (or axle side) of the wheel.

In some embodiments, the sealing element 306 is a separate structure. In other embodiments, the sealing element 306 is a unified portion of the shaft 302. In some embodiments, the sealing element 306 is unified with the skirt 304. Other arrangements are contemplated.

In the illustrated embodiment, the cap 310 is secured on an end of the sealing stem 300. In some embodiments, the cap 310 prevents dust and debris from entering the sealing stem 300. In some embodiments, the cap 310 protects components forming a valve core within the sealing stem 300. In some embodiments, the cap 310 may be unified with the securing nut 308. In other embodiments, the cap 310 and the securing nut 308 are separate.

FIG. 4 is a schematic view of another embodiment of a sealing stem 400 for a tire seating tool. In the illustrated embodiment, the sealing stem 400 includes a sealing element 402 that has a partially conical geometry. In some embodiments, the conical geometry of the sealing element 402 allows the sealing element to engage and form a seal with a stem port of a wheel.

FIG. 5 is a schematic view of another embodiment of a sealing stem 500 for a tire seating tool. In some embodiments, the sealing stem 500 includes a sealing element 502 and a backing element 504. In some embodiments, the sealing element 502 is similar in function to the sealing elements shown in previous Figures and described above.

In some embodiments, the sealing element 502 is proximal a backing element 504. In some embodiments, the backing element 504 provides structural support to the sealing element 502. In some embodiments, the backing element 504 improves the seal or engagement of the sealing element 502 with the wheel. In some embodiments, the backing element 504 is bonded or otherwise attached to the sealing element 502. In other embodiments, the backing element 504 is not coupled to the sealing element 502. In some embodiments, the sealing element 502 and the backing element 504 have similar or disparate diameters or geometries.

FIG. 6 is a schematic view of another embodiment of a sealing stem 600 for a tire seating tool. In the illustrated embodiment, the sealing stem 600 includes a compound sealing element 602. In some embodiments, the compound sealing element 602 includes two larger diameter portions and a smaller diameter portion. In the illustrated embodiment, the smaller diameter portion of the compound sealing element 602 has a diameter to fit within the diameter of a stem port.

In some embodiments, the larger diameter portions are configured to form a seal on the axle side and the tire side, respectively, of the wheel to prevent air loss at the sealing stem 600. In some embodiments, the compound seal 602 is applied while inserting the sealing stem 600 into the wheel. In other embodiments, the compound sealing element 602 is applied to the wheel separately and the sealing stem 600 is inserted into the compound sealing element 602.

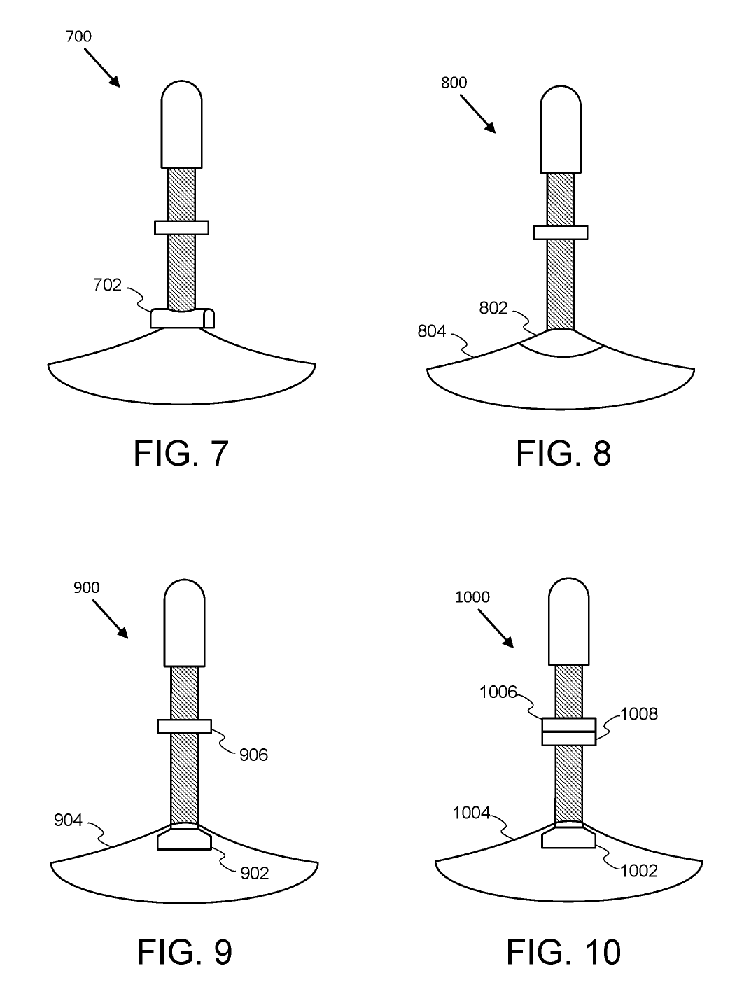

FIG. 7 is a schematic view of another embodiment of a sealing stem 700 for a tire seating tool. The illustrated embodiment of the tire seating tool 700 includes a sealing element 702 which has a curved geometry to match a geometry of a wheel at a tire side surface of the wheel. In some embodiments, the sealing element 702 is flexible. In other embodiments, the sealing element 702 is rigid or semi-rigid. In some embodiments, the sealing element 702 includes a first portion which has a first characteristic and a second portion having a second characteristic different from the first characteristic of the first portion.

In the illustrated embodiment, the sealing element 702 is curved in one dimension. In other embodiments, the sealing element 702 may be curved in another dimension or in multiple dimensions.

FIG. 8 is a schematic view of another embodiment of a sealing stem 800 for a tire seating tool. In the illustrated embodiment, the sealing stem 800 includes a sealing element 802 which is coupled to a skirt 804. In some embodiments, the sealing element 802 is formed of a first material and the skirt 804 is formed of a second material. In other embodiments, the sealing element 802 and the skirt 804 are formed of the same or similar materials.

In some embodiments, the sealing element 802 is thicker than the skirt 804. In other embodiments, the sealing element 802 includes a reinforcement to provide structural resilience to the sealing element 802. In some embodiments, the sealing element 802 includes other structural elements different from the skirt 804. In other embodiment, the sealing element 802 includes a surface treatment or coating not applied to the skirt 804.

FIG. 9 is a schematic view of another embodiment of a sealing stem 900 for a tire seating tool. In the illustrated embodiment, the sealing stem 900 includes a sealing element 902 located on an opposite side of the skirt 904 from a securing nut 906 of the sealing stem 900.

In some embodiments, the sealing element 902 applies force to a portion of the skirt 904 to provide a seal at the sealing stem 900 in response to the securing nut 902 being tightened toward the sealing element 902. The sealing element 902 may be flexible, semi-rigid, or rigid. In some embodiments, the sealing element 902 separates a portion of the skirt 904 from the rest of the skirt 904 in response to a force applied by the securing nut 906.

FIG. 10 is a schematic view of another embodiment of a sealing stem 1000 for a tire seating tool. In the illustrated embodiment, the sealing stem 1000 includes a sealing element 1002 located below a skirt 1004. In the illustrated embodiment, the sealing stem 1000 also includes a securing nut 1006 with a corresponding securing seal 1008. In some embodiments, the securing seal 1008 creates a seal to prevent pressure loss at the sealing stem 1000. In some embodiments, the securing seal 1008 supplements a seal formed by the sealing element 1002.

In some embodiments, the securing nut 1006 and the securing seal 1008 are separate structures. In other embodiments, the securing nut 1006 and the securing seal 1008 are coupled or form a unified structure.

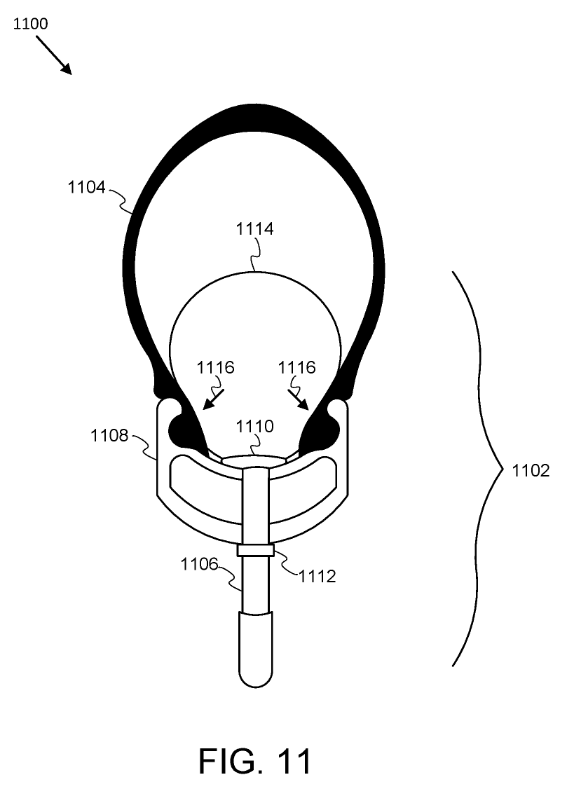

FIG. 11 is a schematic cross-sectional view of one embodiment of a seating tool installed in a tubeless tire system 1100. In the illustrated embodiment of the tubeless tire system 1100, a seating tool 1102 is inserted into the tubeless tire 1104 and the sealing stem 1106 of the seating tool 1102 is passed through the wheel 1108 at a stem port of the wheel 1108.

In the illustrated embodiment, the seating tool 1102 includes a sealing element 1110 to form a seal on the tire side of the wheel 1108 in response to a tightening of the securing nut 1112 along the sealing stem 1106 on an axle side of the wheel. In the illustrated embodiment, the sealing element 1110 is attached to a tube 1114. In some embodiment, the sealing stem 1106 includes an internal valve or valve core to allow air to be driven into the tube 1114 and prevent air from escaping through an internal channel of the sealing stem 1106. As pressure increases in the tube 1114, the tire 1104 is seated on the wheel 1108 by outward forces 1116 which provide a seating pressure of the tube 1114 applied to the tire 1104.

In some embodiments, the tube 1114 is filled to an operating pressure of the tire 1104. In some embodiments, the tube 1114 bursts at, above, or prior to reaching the operating pressure of the tire 1104. In other embodiments, the tube 1114 does not burst before reaching the operating pressure of the tire 1104. If the tube 1114 does burst, the sealing element 1110 prevents air from escaping through the wheel next to the sealing stem 1106.

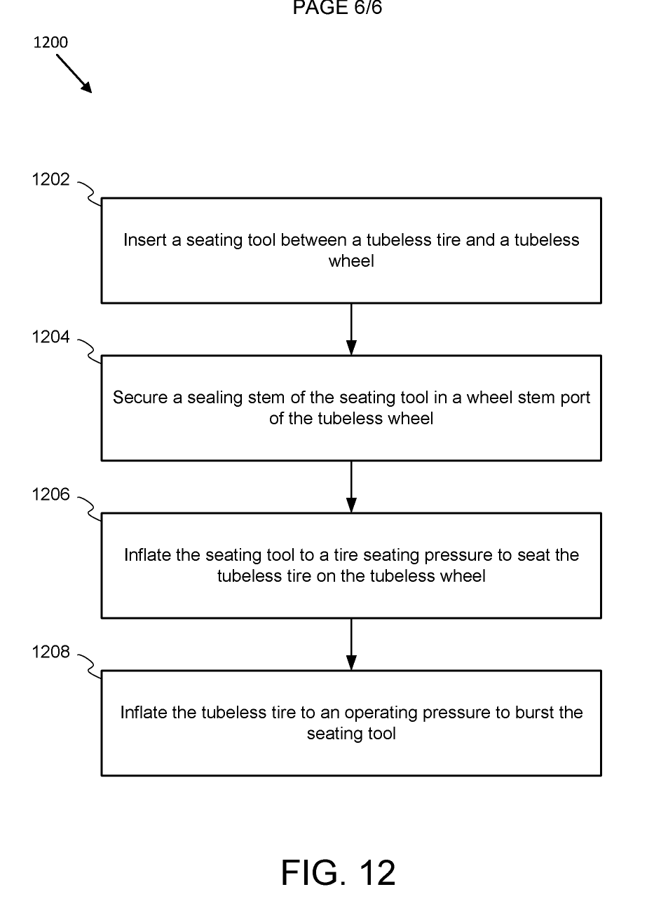

FIG. 12 is a flowchart of one embodiment of a method 1200 for using the seating tool. The illustrated embodiment of the method 1200 includes, at block 1202, inserting the seating tool between the tubeless tire and the tubeless wheel. In some examples, the seating tool may be at least partially pressurized to aid in inserting the seating tool between the tubeless tire and the tubeless wheel.

At block 1204, the method 1200 includes securing the sealing stem in the wheel stem port. In some embodiments, the sealing stem is secured in the wheel stem port with a securing nut. In some embodiments, the securing nut is tightened down against the tubeless wheel at approximately the wheel stem port. In other embodiments, the sealing stem includes a sealing element which secures the sealing stem relative to the wheel stem port.

At block 1206, the method 1200 includes inflating the seating tool to a tire seating pressure to seat the tubeless tire on the tubeless wheel. In some embodiments, the sealing stem accepts air or other fluid driven into the seating tool via a pump or pre-pressurized delivery system. In some embodiments, the seating tool is inflated by a chemical reaction yielding a product capable of filling the seating tool. In some embodiments, the seating pressure is a pressure sufficient to seat a bead of the tubeless tire onto a corresponding portion of the tubeless wheel.

At block 1208, the method includes inflating the tubeless tire to an operating pressure to burst the seating tool. In some embodiment, the seating stem of the seating tool is used to provide sufficient pressure to the tubeless tire to reach an operating pressure of the tubeless tire. In some embodiments, the operating pressure of the tubeless tire is dependent on the terrain or type of use the tubeless tire will experience. In other embodiments, the operating pressure is a pressure suggested by a manufacturer of the tubeless tire. In some embodiments, the operating pressure is a pressure greater than the seating pressure. In some embodiments, a user selects the operating pressure based on other criteria.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A tubeless tire seating tool comprising:
a tube inflatable to apply pressure to a tubeless tire on a tire side of a wheel to seat the tubeless tire on the wheel; and
a sealing stem coupled to the tube to facilitate delivery of a fluid into the tube to apply the pressure to the tubeless tire, the sealing stem comprising a sealing element external to the sealing stem and forming a seal on the wheel to prevent the fluid from escaping around the sealing stem from within the tubeless tire in response to a failure of the tube.

2. The tubeless tire seating tool of claim 1, further comprising a sealing nut disposed on the sealing stem to apply a force to secure the sealing element on the wheel.

3. The tubeless tire seating tool of claim 2, wherein the sealing nut and the sealing element are joined to form a compound sealing element.

4. The tubeless tire seating tool of claim 1, further comprising a cap disposed on an end of the sealing stem opposite the tube.

5. The tubeless tire seating tool of claim 1, further comprising a skirt coupled to the tube and at least one of the sealing stem and the sealing element.

6. The tubeless tire seating tool of claim 5, wherein the sealing element is positioned to be between the skirt and the wheel.

7. The tubeless tire seating tool of claim 5, wherein the sealing element is integrated with the skirt.

8. The tubeless tire seating tool of claim 5, wherein the sealing element is coupled to the sealing stem within the skirt to press the skirt against the wheel.

9. The tubeless tire seating tool of claim 1, wherein the sealing element has an at least partially conical geometry.

10. The tubeless tire seating tool of claim 1, wherein the tube comprises a gap formed in the tube creating a c-shaped geometry.

11. The tubeless tire seating tool of claim 1, wherein the tube comprises a sealant disposed within the tube.

12. The tubeless tire seating tool of claim 1, wherein the tube is configured to burst within the tubeless tire in response to inflation of the tube.

13. The tubeless tire seating tool of claim 12, wherein the tube comprises a weakness formed in the tube at a location where the tube is configured to burst.

14. A tubeless tire system comprising:
a tubeless wheel;
a tubeless tire disposed on the tubeless wheel; and
a tubeless tire seating tool configured to seat and at least partially inflate the tubeless tire on the tubeless wheel, the tubeless tire seating tool comprising:
a tube inflatable to apply pressure to the tubeless tire on a tire side of the tubeless wheel to seat the tubeless tire on the tubeless wheel; and
a sealing stem coupled to the tube to facilitate delivery of a fluid into the tube to apply the pressure to the tubeless tire, the sealing stem comprising a sealing element external to the sealing stem and forming a seal on the tubeless wheel to prevent the fluid from escaping around the sealing stem from within the tubeless tire in response to a failure of the tube.

15. The tubeless tire system of claim 14, wherein the tube is configured to burst at or above a seating pressure of the tubeless tire on the tubeless wheel.

16. The tubeless tire system of claim 15, wherein the tube comprises a weakness formed in the tube at a location where the tube is configured to burst.

17. The tubeless tire system of claim 14, further comprising a sealant disposed within the tube.

18. A method comprising:
inserting a seating tool between a tubeless tire and a tubeless wheel;
securing a sealing stem of the seating tool in a wheel stem port of the tubeless wheel;
inflating the seating tool to a tire seating pressure to seat the tubeless tire on the tubeless wheel; and
inflating the tubeless tire to an operating pressure to burst the seating tool.

19. The method of claim 18, wherein inflating the tubeless tire to an operating pressure comprises bursting the seating tool between the tubeless tire and the tubeless wheel at a weakness formed in the seating tool.

20. The method of claim 18, further comprising bursting the seating tool to apply a sealant to the tubeless tire and the tubeless wheel.
